(19) United States
(12) Patent Application Publication
(10) Pub. No.: US 2010/0237653 A1
(43) Pub. Date: Sep. 23, 2010

(54) SYSTEMS AND METHODS FOR FACILITATING OPERATION OF CARGO DOORS IN VEHICLES AND TRAILERS

(76) Inventor: James D. Rydberg, Huntington, NY (US)

Correspondence Address: EDWARDS ANGELL PALMER & DODGE LLP, P.O. BOX 55874, BOSTON, MA, 02205, US

(21) Appl. No.: 12/729,650

(22) Filed: Mar. 23, 2010

Related U.S. Application Data
(60) Provisional application No. 61/162,603, filed on Mar. 23, 2009.

(51) Int. Cl. E05F 15/12; B62D 33/04; E05F 5/08; E05D 15/00; E06B 9/56; E06B 3/00

(52) U.S. Cl. 296/182.1; 49/324; 16/85; 160/311; 49/506; 340/825.22

(57) ABSTRACT

The disclosure includes, among other things, a trailer including a base, a plurality of walls extending upwardly from the base, a cargo door displaceable between an open position and a closed position, a motorized spool, and a cable having a first end attached proximate the spool and a second end attached to the cargo door, wherein the door can be moved between the open position and the closed position by operating the motorized spool.

### CROSS-REFERENCE TO RELATED APPLICATION

This patent application claims priority to U.S. Provisional Patent Application Ser. No. 61/162,603, filed Mar. 23, 2009. The aforementioned patent application is incorporated by reference herein in its entirety.

### BACKGROUND

1. Field of the Disclosure

The disclosed embodiments relate to systems and methods for facilitating the use of cargo doors on truck bodies. Particularly, the disclosed embodiments are directed to a system and method to facilitate the opening of doors for cargo vehicles.

2. Description of Related Art

Cargo trucks and vans can be provided with a variety of cargo doors. While some have hinged swing doors or bifold doors that open along vertically-oriented hinges, other cargo doors include roll-up doors that open by being lifted along a vertical direction. Roll-up doors generally have horizontally-oriented panels that are hinged together to permit the door to articulate as it is rolled up along side rails until it is parallel to the roof of the vehicle. Spring-based mechanical assist devices have been used for some time to facilitate the opening of such doors. Other doors such as ramp doors, which are hinged at the bottom and are used as a ramp, have been used widely in trailers, such as those used to transport horses and those used by contractors to transport tools or mobile workshops. To the best of the knowledge of Applicant, aside from spring-assist devices, no other refinements have been made to facilitate the opening of such roll-up and ramp doors. The disclosed embodiments provide a number of improvements and refinements that address deficiencies in previous approaches.

### SUMMARY OF THE DISCLOSURE

The purpose and advantages of the disclosed embodiments will be set forth in and become apparent from the description that follows. Additional advantages of the disclosed embodiments will be realized and attained by the methods and systems particularly pointed out in the written description hereof, as well as from the appended drawings.

To achieve these and other advantages and in accordance with the purpose of the disclosed embodiments, as embodied herein, the disclosure includes a trailer. The trailer includes a base, a plurality of walls extending upwardly from the base, a cargo door displaceable between an open position and a closed position, a motorized spool, and a cable having a first end attached proximate the spool and a second end attached to the cargo door, wherein the door can be moved between the open position and the closed position by operating the motorized spool.

In accordance with a further aspect, the door may be a ramp door hingedly attached to the base, and the cable may accordingly be routed through a bearing proximate the door opening to provide a predetermined angle of inclination of the cable with respect to the plane of the ramp door to provide sufficient leverage to close the door. If desired, the trailer can further include a door stop including at least one of a spring and a shock absorber to ease closure of the door during operation of the motor. If desired, the motor can be operated manually by a switch. Preferably, the motorized spool automatically shuts off when the stop has been fully compressed. The stop can be adapted to urge the door into an open position to facilitate opening the door. In accordance with one embodiment, the door includes a spring that is adapted to urge the door open. In accordance with a further aspect, the door can be provided with a weight distribution that is optimized to cause the door to open from a closed position when tension on the cable is decreased.

In accordance with still a further aspect the trailer can further include a control system adapted and configured to control the delivery of power to motor from a power supply based on user input. In accordance with one embodiment, the control system is operable by a wireless control. In accordance with another aspect, the cable can be adapted and configured to be routed into a secondary position to facilitate loading the trailer with cargo.

In accordance with still a further aspect, the motor and cable can prevent the door from opening when not in use to prevent break-in. For example, the control system can permit operation of the motor by way of an access code. By way of further example, the motor can be operable by a key-operated switch.

In accordance with still another embodiment, the door can be a vertically displaceable roll up door.

The disclosed embodiments further provide a method. The method includes providing a trailer as disclosed herein, disconnecting the cable from the door, routing the cable through a second path, attaching the cable to an object to be moved onto the trailer; and operating the motor to move the object onto the trailer.

The accompanying drawings, which are incorporated in and constitute part of this specification, are included to illustrate and provide a further understanding of the methods and systems of the disclosed embodiments. Together with the description, the drawings serve to explain the principles of the disclosed embodiments.

### BRIEF DESCRIPTION OF THE DRAWINGS

The accompanying drawings, which are incorporated in and constitute part of this specification, are included to illustrate and provide a further understanding of the methods and systems of the disclosed embodiments. Together with the description, the drawings serve to explain the principles of the disclosed embodiments.

FIG. 1 is schematic isometric view of a utility trailer having a ramp door incorporating a first representative embodiment of a system made in accordance with the disclosed embodiments.

FIG. 2 is a partial schematic isometric view of a cargo trailer having a roll-up door incorporating a second representative embodiment of a system made in accordance with the disclosed embodiments.

### DETAILED DESCRIPTION OF THE PREFERRED EMBODIMENTS

Reference will now be made in detail to the present preferred embodiments, examples of which are illustrated in the accompanying drawings. The methods and corresponding steps of illustrative embodiments of the disclosure will be described in conjunction with the detailed description of the system.

To the best of Applicant's knowledge, only mechanical spring mechanisms have been used to facilitate the opening of ramp doors and roll-up doors that can commonly be found on cargo trucks (e.g., box trucks), utility trailers, cargo trailers, and the like. While such mechanisms are helpful to some extent to facilitate the opening of cargo doors, it is not unusual for a user to need to exert a significant amount of physical effort to close or open such doors.

Applicant has developed various embodiments for addressing these problems by adding a powered feature to further assist the opening and closing of ramp doors.

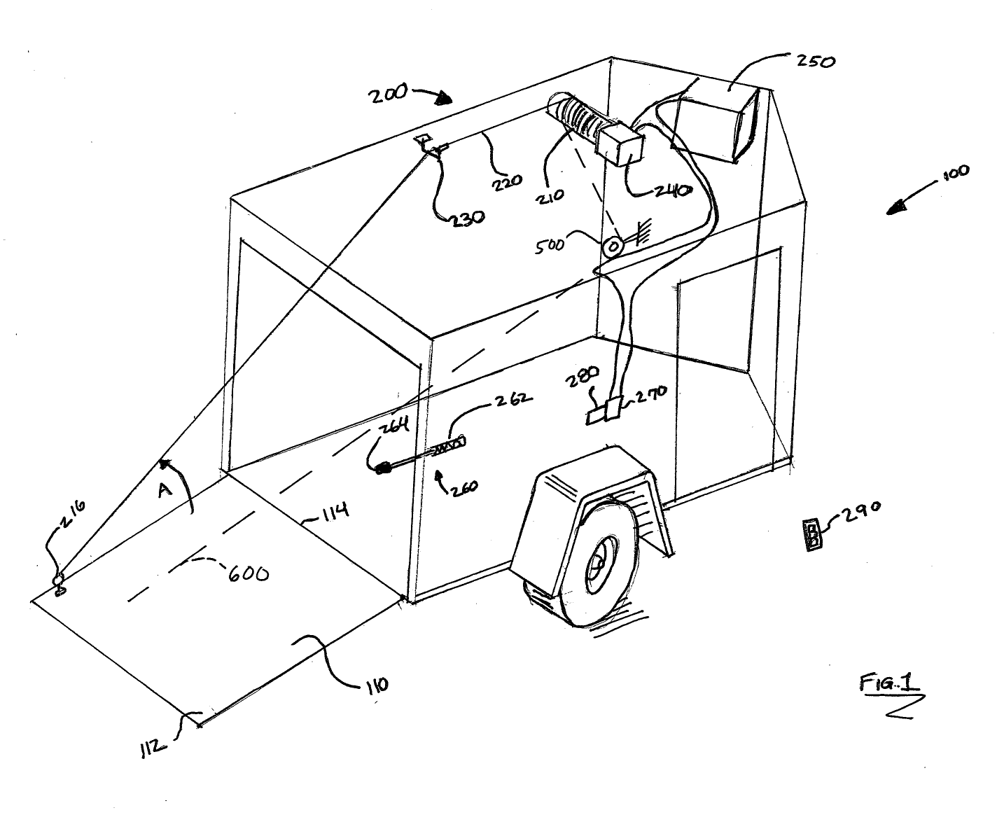

In accordance with a first embodiment, as illustrated in FIG. 1, an exemplary system is provided for motorized opening of a trailer (or truck) having a ramp door. Specifically, a cargo trailer 100 is provided having a rear ramp door 110 illustrated in an open position. In accordance with the subject disclosure, a door closing system 200 is provided including a motorized spool 210 that is operably coupled to a windable cable 220 that is in turn routed to an end 112 of door 110. As illustrated, cable 220 is routed through a bearing 230 to provide for an advantageous angle of inclination “A” of the cable with respect to the plane of the ramp door 110 to provide sufficient leverage to close the door. Spool 210 is operably coupled to a motor 240 which is in turn operably coupled to a power supply 250. If desired, a door stop 260 may be provided including a spring and/or shock absorber 262.

In operation, starting from an open position, the system 200 is activated by turning on the motor 240 to cause the spool 210 to rotate and pull on and wind the cable 220. Tension in the cable is transmitted to the attachment point 216 on ramp door 110, causing ramp door 110 to begin to close by rotating about hinge 114. The end 112 of door is pulled upward until it engages stop 260. Stop 260 can include a linear gas cylinder that compresses as door 110 closes. It will be appreciated that the control of motor can be fully manual, such as by providing a switch 270 that may be operated by a user. In addition, if desired, motor can be adapted to shut off automatically when the stop 260 is fully compressed. Then, when re-opening the door, stop 260 can help urge the door 110 outward to a point where the weight of the door pulls on the cable 220, and the door is lowered by the system 200. It will be further appreciated that door 110 can be provided with an optimized weight distribution or an opening spring that will cause the door to open under its own weight or other force when tension on the cable is decreased.

In addition with another embodiment, a control system 280 can be provided that controls the delivery of power to motor 240 based on user input. Operation of control system 280 may be by done via pressing a button on the outside of the trailer 100. By way of further example, if desired, control system 280 may be activated by a wireless remote control 290 by a user. When closed, system 200 can hold door 110 closed helping to prevent break-in and theft. Specifically, when tension on the cable 220 is significant, the door 110 is held tightly closed. This can eliminate the need for any other locking mechanism on the door, such as latches, padlocks or the like. Moreover, the control system can be limited to access by a particular frequency or code to help facilitate security. If manual control of the motor on the spool is desired, it can be provided by an electrical switch that can only be operated by a key, thus providing added security.

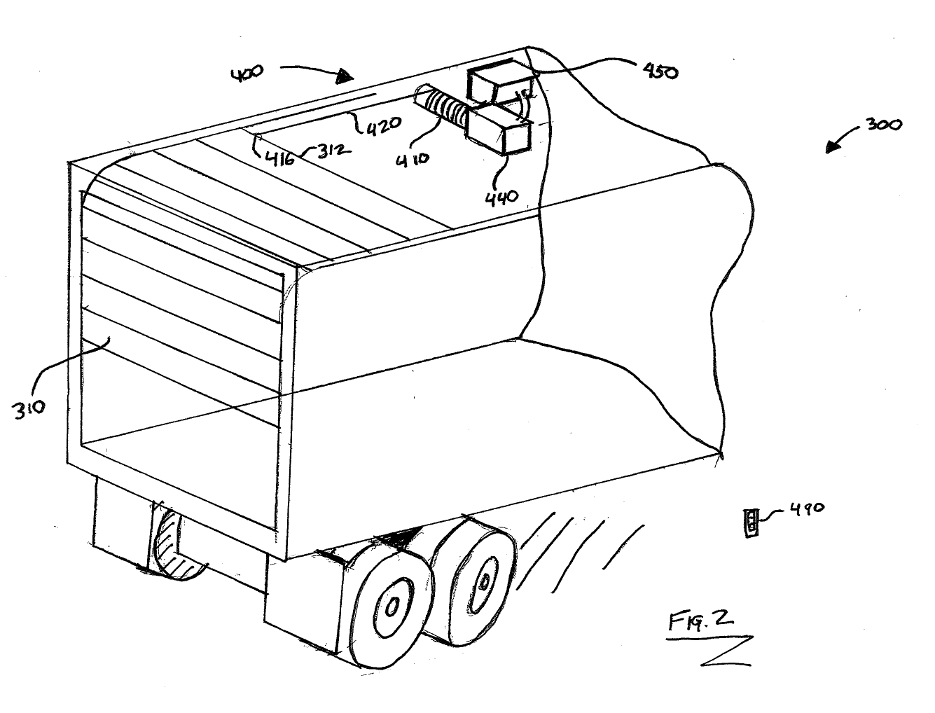

In accordance with a second embodiment, FIG. 2 illustrates use of a system to facilitate opening of a roll-up door on a trailer or vehicle. As depicted, a trailer 300 is provided having a roll-up door 310 that is operably coupled to system 400. Specifically, a first end of cable 420 is operably coupled to upper end 312 of door 310 at an attachment point 416. The other end of cable 420 is operably coupled to spool 410 which, in turn, is coupled to motor 440. Motor 440 may be selectively coupled to power supply 450 in any manner as described with respect to the embodiment of FIG. 1 (e.g., via wireless remote 490).

If desired, the systems (200, 400) provided herein may by provided with a newly manufactured trailer or vehicle. In accordance with a further embodiment, if desired, systems (200, 400) may be provided as a retrofit kit that can be installed at a trailer or vehicle dealership, or by a purchaser or user, as desired.

The power supply (250, 450) described herein may be provided in any desired form. In accordance with one embodiment, the power supply may include an battery and/or generator on board the trailer or vehicle. If desired, power may be drawn from a tow vehicle as well. If desired, power on-board a trailer may be provided by a battery, generator (e.g., gasoline motor powered or electrochemical fuel cell), and/or solar cells on the roof of the trailer, among other things.

The spool (210, 410) and motor (240, 440) may be provided, for example, in the form of a winch mechanism such as those made by various manufacturers (e.g., from Warn Industries). Selection of a proper spool and motor, as well as the other system components, should permit long-term operation of the system. While cable (220, 420) can be of any suitable material, is preferably made from steel cable.

In accordance with a further embodiment, the spool (210, 410), motor (240, 440) and cable (220, 420) may be adapted for selective use in hauling heavy objects onto the trailer. This feature is particularly advantageous in the embodiment of FIG. 1, as a heavy object can be pulled up the ramp door by detaching the cable from the door, and routing it through additional bearings or pulleys (e.g., 500) attached, for instance, to the back wall of the trailer to direct the cable to an advantageous path (600) for attaching to heavy objects to haul into the trailer.

The methods and systems of the present disclosure, as described above and shown in the drawings, provide for vehicles and trailers that are easier and safer to use. It will be apparent to those skilled in the art that various modifications and variations can be made in the devices and methods of the present disclosure without departing from the spirit or scope of the disclosure. Thus, it is intended that the present disclosure include modifications and variations that are within the scope of the subject disclosure and equivalents.

1. A trailer, comprising;
a) a base;
b) a plurality of walls extending upwardly from the base;
c) a cargo door displaceable between an open position and a closed position;
d) a motorized spool;
e) a cable having a first end attached proximate the spool and a second end attached to the cargo door, wherein the door can be moved between the open position and the closed position by operating the motorized spool.

2. The trailer of claim 1, wherein the door is a ramp door hingedly attached to the base, and the cable is routed through a bearing proximate the door opening to provide a predetermined angle of inclination of the cable with respect to the plane of the ramp door to provide sufficient leverage to close the door.

3. The trailer of claim 2, wherein the trailer further comprises a door stop including at least one of a spring and a shock absorber to ease closure of the door during operation of the motor.

4. The trailer of claim 1, wherein the motor is manually operable by a switch.

5. The trailer of claim 3, wherein the motorized spool automatically shuts off when the stop has been fully compressed.

6. The trailer of claim 3, wherein the stop is adapted to urge the door into an open position to facilitate opening the door.

7. The trailer of claim 1, wherein the door includes a spring that is adapted to urge the door open.

8. The trailer of claim 1, wherein the door has a weight distribution that is optimized to cause the door to open from a closed position when tension on the cable is decreased.

9. The trailer of claim 1, further comprising a control system to control the delivery of power to motor from a power supply based on user input.

10. The trailer of claim 9, wherein the control system is operable by a wireless control.

11. The trailer of claim 9, wherein the cable is adapted and configured to be routed into a secondary position to facilitate loading the trailer with cargo.

12. The trailer of claim 9, wherein the motor and cable prevents the door from opening when not in use to prevent break-in.

13. The trailer of claim 12, wherein the control system permits operation of the motor by way of an access code.

14. The trailer of claim 1, wherein the motor is operable by a key-operated switch.

15. The trailer of claim 1, wherein the door is a vertically displaceable roll up door.

16. A method comprising:
) providing the trailer of claim 1;
b) disconnecting the cable from the door;
c) routing the cable through a second path;
d) attaching the cable to an object to be moved onto the trailer; and
e) operating the motor to move the object onto the trailer.
